(19) United States
(12) Patent Application Publication
(10) Pub. No.: US 2009/0199672 A1
(43) Pub. Date: Aug. 13, 2009

(54) Universal Selector Shaft for Motor Vehicle Transmissions

(76) Inventor: John Impellizeri, Knoxville, TN (US)

Correspondence Address: PITTS AND BRITTIAN P C, P O BOX 51295, KNOXVILLE, TN, 37950-1295, US

(21) Appl. No.: 12/027,318

(22) Filed: Feb. 7, 2008

(51) Int. Cl. F16H 59/02

(52) U.S. Cl. 74/473.21

(57) ABSTRACT

Apparatus, including a novel selector shaft, for use in the shifting of gears in an automatic transmission of a motor vehicle. This shaft is provided with means whereby the permissible (start and stop) rotation of the selector shaft is subdivided into individually small increments, any increment being available as an adjustable aspect of the location and/or design of a given linkage which interconnects the selector shaft to a gear shifter. The present selector shaft therefore is substantially universally adaptable to known existing transmissions and gear shifter combinations.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to motor vehicle automatic transmissions and more particularly to mechanisms employed for the shifting of gears in such transmissions.

### BACKGROUND OF INVENTION

Automatic transmissions employed in certain motor vehicles provide for the “changing of gears” through the means of a gear shifter located within the interior of the vehicle and accessible to a driver of the vehicle. Automatic transmissions operate on the principle of diversion of the flow of transmission fluid within a transmission case. Choice of one or more of these flow paths functions to selectively deliver from the engine output shaft to the drive train of the vehicle selected torque and/or speed of rotation, etc. for selected movement (or lack of movement) of the motor vehicle.

In the present disclosure, the term “gear” is at times employed to describe the flow path(s) of transmission fluid within the transmission case as is well known in the art.

Commonly, the selection of these flow path(s)s is performed by means of a selector “gear” disposed within the transmission case. By design, movement of this selector gear is limited to movement between first and second positions of the gear. Activation of this selector gear commonly is effected by means of a selector shaft which is mounted within the wall of the transmission case. An inboard end of the selector shaft is located within the transmission case in operative engagement with the selector gear. The opposite and outboard end of the selector shaft projects outside the transmission case. This outboard end of such shaft is presented for interconnection with linkage which ultimately leads to a gear shifter which is operable by the driver of the vehicle for selection of gears (ie. “shifting gears”).

Rotation of the selector shaft about its longitudinal centerline functions to operate the selector gear, that is, to move the selector gear between multiple positions between its first and second limits of movement.

The degree of rotation of the selector shaft between beginning and ending limits serves to rotate the selector gear, also between beginning and ending limits. In practice, the selector gear may be rotated between a beginning position designated as the “park” position (gear), through “reverse”, “drive”, “second” and to an ending position of “first”. Other combinations of “gears” are employed in the art, but the operation of the selector shaft is substantially the same irrespective of the combination of gears employed. Inasmuch as the selector shaft may not be rotated through a full 360 degree movement due to its connection to the selector gear, the permissible rotational beginning and ending limits of rotation of the selector shaft must be initially coordinated (at times referred to in the industry as “clocking”) with the beginning and ending limits of movement of the selector gear within the transmission so that incremental movements of the gear shifter by the driver within the vehicle will be religiously converted through the selector shaft and the selector gear into the intended selection of gears by the driver.

Since the choice of selectable gears must be available to the driver inside the vehicle, the gear shifter disposed within the vehicle is operatively connected to the selector shaft, which in turn, is connected to the selector shaft associated with the transmission. In any given version of an automatic transmission and/or type or location of the gear shifter located within the vehicle, there will be a required combination of linkage which operatively connects the gear shifter to the selector shaft for rotation of the selector shaft upon movement of the gear shifter, hence selection of the desired gear.

As noted, selection of a particular combination of gears involves rotation of the selector shaft through the means of the gear shifter and the linkage interposed between the gear shifter and the selector shaft. Because the gear selector disposed within the transmission case may rotate (oscillate) only between first and second limits (between “park” and “first”, for example), its associated selector shaft, in like manner, is limited to like rotational movement between such beginning and ending limits. In the prior art, when one desired to install an aftermarket gear shifter associated with a transmission for a given vehicle (e.g. Ford, Chevrolet, etc.), depending upon the location of the gear shifter within the inside of the vehicle and/or its mounting location within the vehicle (e.g. floor mount or steering column mount), it became necessary to design a linkage suitable for converting movement of the gear shifter into rotation of the selector shaft, hence corresponding movement of the gear selector within the transmission. In such instances, the linkage design was required to accommodate and convert incremental movement of the gear shifter along a fixed path in the course of selecting gears, into appropriate associated rotational movement of the selector shaft. Most frequently, the design and ultimate construction of appropriate linkage involved a relatively large number of components, calculation of angular relationships, etc., plus time consuming and costly trial and error to determine the final construction and physical adjustments of the linkage.

In the prior art, it has been common to provide a specifically designed selector shaft for a given shifter. In certain prior art selector shafts, there is provided a lever arm associated with the selector shaft and to which the linkage may be connected for rotation of the selector shaft. Heretofore, this lever arm has been formed as an integral part of the selector shaft so that such selector shaft was usable only with a certain shifter or one of a certain type of shifters. In each event, heretofore there was no desirable provision for changing the “fixed” relationship of the lever arm to the selector shaft. Essentially the only adjustability possible when employing such prior art selector shafts was to rotate the selector shaft by 180 degrees when installing the selector shaft in given transmission.

Not uncommonly, vehicle owners desire to “customize” the type and/or location of the vehicle shifter within the vehicle. Thus, in the absence in the prior art of the needed adjustability of the selector shaft and the linkage needed to interconnect the selector shaft to the shifter, there are now marketed separate linkage systems which effectively link the shifter to the selector shaft while accommodating the physical location of the shifter within the vehicle. For example, linkage systems may include flexible cables for interconnecting the shifter and the selector shaft. Or, the linkage may require access to the lever on the selector shaft from any of a large range of angles, depending upon the relative locations of the gear shifter and the selector shaft.

### BRIEF DESCRIPTION OF THE FIGURES

FIG. 1 is a representation, partly exploded, of a portion of a typical transmission case and one embodiment of an associated selector shaft embodying various features of the present invention;

FIG. 2 is a representation, partly exploded, of a typical system for interconnecting a gear shifter, via a linkage, to a selector shaft/lever arm combination, thence to a gear selector disposed within a transmission care, and embodying various of the features of the present invention;

FIG. 3 is a perspective view of one embodiment of a selector shaft embodying various of the features of the present invention;

FIG. 4 is a perspective view of one embodiment of a lever arm adapted to be adjustably connected to the selector shaft depicted in FIG. 3;

FIG. 5 is a perspective, exploded, view of a selector shaft as depicted in FIG. 3 and lever arm as depicted in FIG. 4 and their interconnectablity with one another.

### SUMMARY OF THE INVENTION

In accordance with one aspect of the present invention, there is provided a novel selector shaft for use in the shifting of gears in an automatic transmission of a motor vehicle. This shaft is provided with means whereby the permissible (start and stop) rotation of the selector shaft is subdivided into individually small increments, any increment being available as an adjustable aspect of the location and/or design of a given linkage which interconnects the selector shaft to a gear shifter. The present selector shaft therefore is substantially universally adaptable to known existing transmissions and gear shifter combinations.

### DETAILED DESCRIPTION OF THE INVENTION

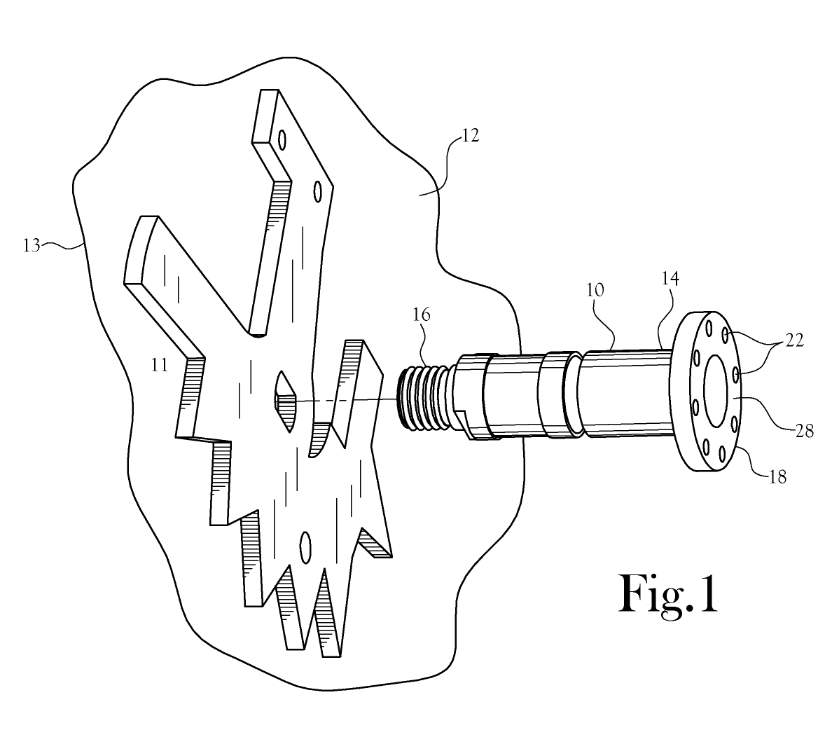

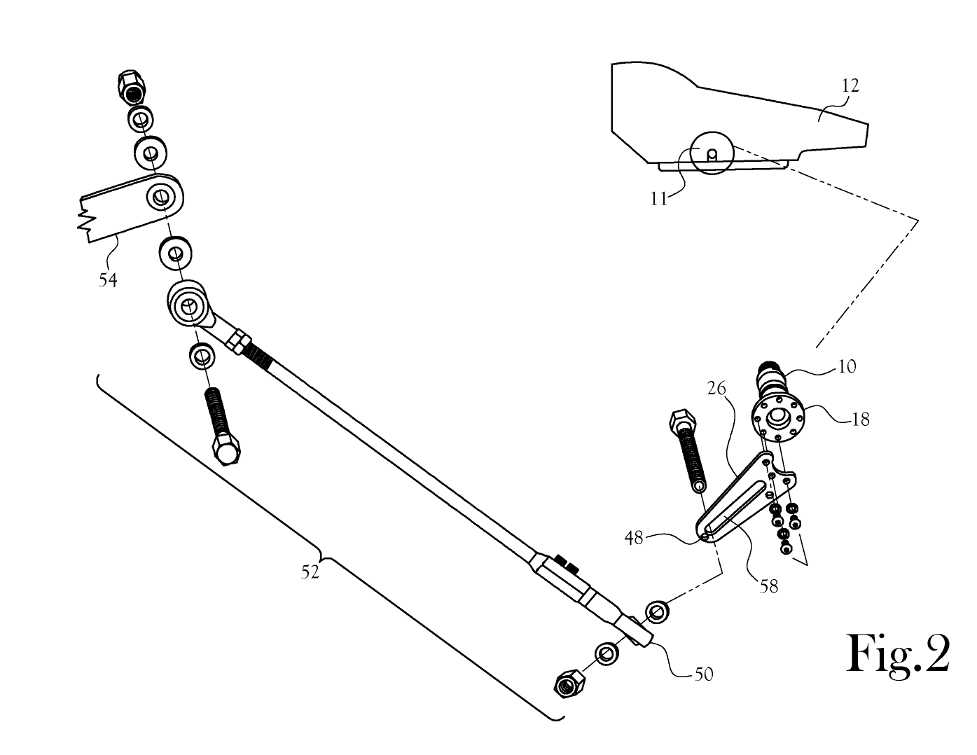

Referring to FIGS. 1 and 2, in one embodiment of the present invention, a selector shaft 10 is connected through a lever arm 26 and linkage 52 to a shifter 54 so that movement of the shifter effects rotation of the selector shaft by an amount which is a function of the degree of movement of the shifter by the vehicle driver. Thus, it is critical that the ratio of movement of the shifter to the resultant rotation of the selector shaft be carefully selected and thereafter established through appropriate adjustments and then the system be “locked” to avoid possible future undesirable changes in the established ratio. Further, it will be recognized that the physical position of the shifter within the vehicle, relative to the physical position and the desired range of rotational positions of the selector shaft imposes limitations on how one connects the shifter to the selector shaft, thence to the selector gear. For example, when the gear shifter is located to the rear of the transmission, the manner in which the linkage can be connected to the selector shaft differs materially from the manner in which the same shifter can be connected to the same selector shaft when the shifter is physically positioned forward of the selector shaft. More specifically, rotation of the selector shaft functions to move the selector gear between predetermined positions of the selector gear between its first and second limits of movement. Each of such positions of the selector gear represents a “gear position” such as “Park”, “Reverse”, “Neutral”, “Drive”, “Second”, “First” (P R N D 2 1). Other transmissions may exhibit a different order of the gearing, but in all instances, the selector gear will necessarily proceed through a limited range of multiple gear positions. Further, in all instances, the direction and/or extent of rotation of the selector shaft will determine which gear position the selector gear resides in at any given time.

As depicted in the several figures, the proper ratio between the movement of the shifter 54 disposed within the interior of the vehicle where it is accessible by the driver, to the rotation of the selector shaft 10, is a function of the specific combination of shifter and style of transmission involved as is well recognized by those skilled in the art. In addition to such ratio of motions, it is imperative that the movement of the shifter by the vehicle driver not be capable of rotating the selector shaft beyond those start and stop limits which represent the permissible limits of movement of the selector gear disposed within the transmission. In short, the movements of the shifter must be accurately coordinated with the movements of the selector gear within the transmission. This is true with respect to the desired positions of the selector gear intermediate its first and second limits of movement, i.e. P R N D 2 1, for example.

Accordingly in one embodiment, the present invention includes a selector shaft 10 having on its outboard end 14 a circumferential flange 18 which is oriented in a plane preferably substantially perpendicular to the rotational centerline 20 of the selector shaft. This flange 18 projects laterally, preferably radially, outwardly of the selector shaft to present an overhanging peripheral margin portion 24 outboard of the shaft. In this embodiment, the flange of the selector shaft is provided with a plurality of spaced apart bores 22, the centerline of each bore being aligned with a radius of the selector shaft rotational centerline 20. In one embodiment, these bores are internally threaded. Further, in a preferred embodiment, these bores are equally spaced apart from one another.

In the depicted embodiment, the selector shaft 10 is accompanied by a rigid lever arm 26 which extends generally laterally from the rotational centerline of the selector shaft and substantially parallel to the plane of the circumferential flange on the outboard end of the selector shaft. One end 34 of the lever arm is provided with throughbores 40 aligned with one another such that such throughbores on the end 34 of the lever arm may be registered with respective ones of the bores 22 in the circumferential flange 18. Employing conventional screws 46, for example, or other removable fasteners, the lever arm may be removably affixed to the selector shaft at any of a very large number of angular positions about the longitudinal centerline of the selector shaft, thereby providing for substantially any practical initial rotational orientation of the lever arm about the outer circumference of the selector shaft.

In the present invention, the outboard end 32 of the lever arm is available for the connection thereto of linkage 52 interconnecting the lever arm with the gear shifter. By this means, there is provided a substantial enhancement of the permissible orientation (design) of the linkage which may be required to operatively interconnect the gear shifter to the lever arm, hence to the selector shaft, all without disturbing or rearrangement of the engagement of the selector shaft and the gear selector disposed internally of the transmission case.

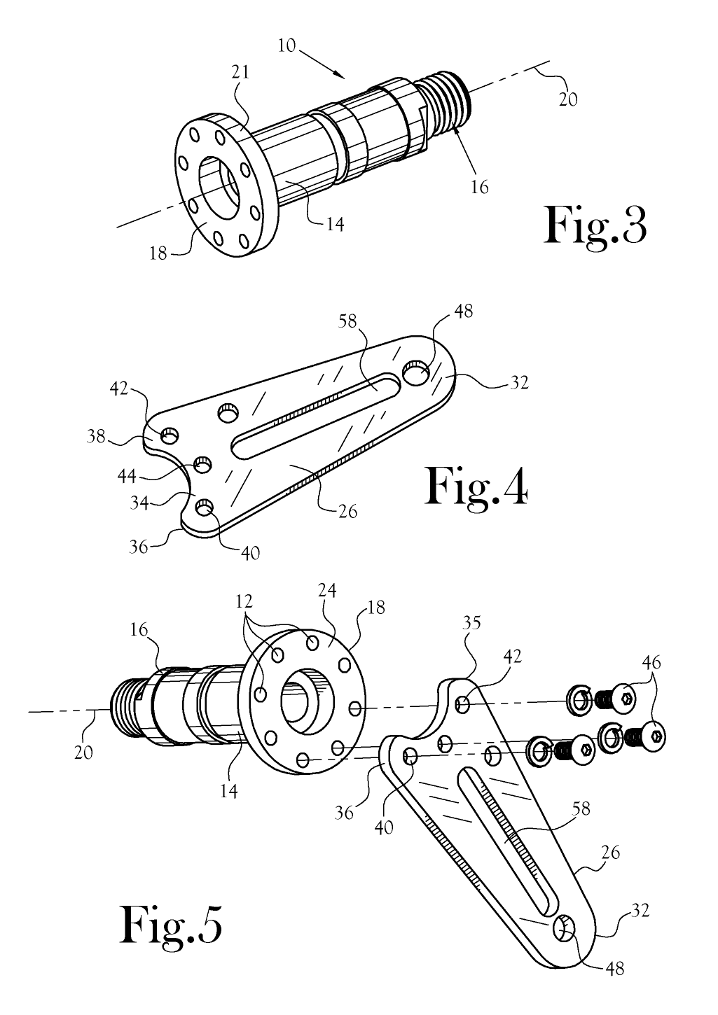

Referring to FIG. 1, there is depicted one embodiment of a selector shaft 10 of the present invention as mountable in a transmission case 12. FIG. 3 depicts a selector shaft as shown in FIG. 1 and includes an inboard end 14, an outboard end 16, and a circumferential flange 18 defined on the outboard end of the selector shaft. Notably, this flange occupies a plane which is substantially perpendicular to the longitudinal centerline 20 of the selector shaft and extends radially outwardly of the selector shaft by a distance sufficient to provide space for a plurality of bores 22 which may extend through the thickness of the flange or may be blind bores. In the depicted embodiment, these bores are internally threaded. These bores are spaced apart from one another by equal distances about the circumferential outer margin 24 of the flange. As depicted, these bores also are displaced radially equidistant from the longitudinal centerline of the selector shaft.

FIG. 4 depicts one embodiment of a lever arm suitable for attachment to the outer surface 28 of the flange 18. The depicted lever arm comprises an elongated flat strip, preferably formed of a metal, and having an outboard end 32 and an inboard end 34. The inboard end of the depicted lever arm includes first and second lateral projections 36 and 38, respectively, each of which is provided with a throughbore 40 and 42, respectively. In the depicted embodiment, a third bore 44 is provided intermediate the bores of the first and second lateral projections. These bores are aligned with their respective centerlines aligned along an arc which is identical to the arc along which the bores of the selector shaft flange are aligned. Further, and referring also to FIG. 5, the bores of the inboard end of the lever arm are spaced apart by the same spatial separation as are the bores of the selector shaft flange so that upon placement of the inboard end of the lever arm in overlying relationship with the selector shaft flange, the bores of the lever arm may be positioned in register with the respective ones of the bores of the selector shaft flange. Once so positioned, screws 46 or other appropriate fasteners, may be inserted into the registered bores of the lever arm and the bores in the flange of the selector shaft to rigidly join the lever arm to the selector shaft. In the depicted embodiment, this interconnection of the lever arm and the selector shaft flange is by means of screws threaded into the internally threaded bores of the selector shaft flange.

It is to be noted that in the depicted embodiment, there are provided eight bores in the selector shaft flange. Accordingly, these bores are separated from one another by 45 degrees, center to center. This arraying of the bores permits positioning of the lever arm on the selector shaft flange in rotational increments of 45 degrees. It will be recognized that more or fewer spaced apart bores may be provided about the circumferential margin of the selector shaft flange if other incremental rotational adjustment values are desired. Moreover, the availability of such 45 degree incremental positioning of the lever arm on the selector shaft extends through the full 360 degree circumference of the selector shaft flange, thereby rendering the present selector shaft/lever arm combination useful in any needed rotational position due to the location of the shifter within the vehicle, among other things.

The bores 22 in the circumferential flange of the selector shaft preferably are equally spaced apart from one another, but other spacings of these bores may be employed. In any event, this shaft is provided with means whereby the permissible (start and stop) rotation of the selector shaft is subdivided into individually small increments, for example 45 degrees increments, any increment being available as an adjustable aspect of the location and/or design of a given linkage which interconnects the selector shaft to a gear shifter. Thus, the present selector shaft is substantially universally adaptable to known existing transmissions and gear shifter combinations.

As seen in FIG. 4, in the depicted embodiment, the outboard end 32 of the lever arm is provided with a throughbore 48. As may be seen in FIG. 2, one end 50 of linkage 52 leading from the gear shifter to the lever arm may be anchored in the throughbore in the outboard end of the lever arm. Thus, upon operation of the gear shifter by the vehicle driver, the linkage acts through the lever arm, thence through the selector shaft to rotate this selector shaft through the full range of its limits of rotation for movement of the selector gear, hence selection of the gear selected by the vehicle driver. As in the prior art, the selection of the extent of rotation of the selector shaft (within its limits of rotation) determines which combination of gears is selected at any given time.

Notably, the present invention provides enhanced ability to effect small or large adjustments in the interconnection of the shifter and the selector shaft within the beginning and ending limits of desired rotation of the selector shaft. Preferably, the lever arm includes an elongated open slot 58 extending from proximate the inboard end of the lever arm to proximate the outboard end of the lever arm. This slot may be employed to adjust the ratio of gear shifter movement to rotation of the selector shaft after the “clocking” of the initial rotational position of the selector shaft and selection of the mounting position of the lever arm on the selector shaft. Alternatively, spaced apart bores may be substituted for the elongated slot, but such provide less degree of adjustability than is provided by a slot.

While the present invention has been illustrated by description of several embodiments and while the illustrative embodiments have been described in considerable detail, it is not the intention of the applicant to restrict or in any way limit the scope of the invention to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept. For example, whereas the present invention has been described as including a circumferential flange defined on one end of the selector shaft and which serves as the interconnection location of a linkage with the selector shaft, it will be recognized that multiple spaced apart projections extending radially outwardly from the outboard end of the selector shaft may be employed as location(s) for interconnection of the selector shaft with a linkage which is interposed between such radial projections and a gear shifter located in operative relationship to a drive of the motor vehicle.

Moreover one skilled in the art will recognize that means other than bores and cooperating removable fasteners for interconnecting registered bores may be employed for removably interconnecting one end of the lever arm to the selector shaft at radially spaced apart locations about the outer circumference of the selector shaft. One such alternative may employ pins projecting from the lever arm which are insertable in bores associated with the selector shaft, such pins being secured in place employing cotter pins fed through bores in the end of each such pin.

What is claimed:

1. Apparatus for operatively interconnecting a selector shaft having a first end and a rotational centerline and useful for operative interconnection of a gear shifter of a motor vehicle to a selector gear associated with a transmission of the motor vehicle comprising
a plurality of spaced apart locations defined on the first end of the selector shaft and adapted for cooperative interconnection of the first end of the selector shaft with an elongated lever arm;
an elongated lever arm having a first end and a second end, said first end including at least one location thereon providing for cooperative interconnection of said first end of said lever arm with at least one of said plurality of spaced apart locations on the first end of the selector shaft and whereby movement of said lever arm is converted into rotational movement of the selector shaft.

2. The apparatus of claim 1 wherein said cooperative interconnection of said first end of said lever arm with the first end of the selector shaft includes removable fastener means compatible with respective ones of said multiple spaced apart locations included on the selector shaft and said at least one location on said lever arm.

3. The apparatus of claim 1 wherein the first end of the selector shaft includes a circumferential flange defined on the first end of the selector shaft and projecting from the selector shaft laterally from the rotational centerline of the selector shaft;
said circumferential flange including multiple spaced apart locations for cooperative interconnection of said first end of said lever arm with said circumferential flange.

4. The apparatus of claim 3 wherein said location on said first end of said lever arm is adapted for registration with at least one of said multiple spaced apart locations on said circumferential flange, said registration providing for receipt of at least one removable fastener whereby said lever arm and said circumferential flange of the selector shaft are connected for conversion of movement of said lever arm into rotational movement of the selector shaft about its rotational centerline.

5. The apparatus of claim 3 wherein each of said multiple spaced apart locations on said circumferential flange defines a bore.

6. The apparatus of claim 5 wherein said at least one location on said first end of said lever arm defines a bore which is registerable with at least one of said multiple spaced apart bores of said circumferential flange of the selector shaft, and further including means for removably operatively interconnecting said registered bores.

7. In a selector shaft having an outboard end and a rotational centerline useful for the operative interconnection of a gear shifter disposed remote from a gear selector associated with a transmission of a motor vehicle, the improvement comprising
a circumferential flange, having an outer circumferential portion, defined on the first end of the selector shaft, said flange extending radially from and in a plane substantially perpendicular to, the rotational centerline of the selector shaft and defining an outboard circumferential portion of said flange,
a plurality of defined locations spaced apart from one another about said outboard circumferential portion of said flange.

8. The selector shaft of claim 7 wherein each of said plurality of defined locations comprises a bore.

9. The selector shaft of claim 8 wherein each of said plurality of defined locations comprises a throughbore.

10. The selector shaft of claim 7 wherein each of said defined locations resides on a radius emanating from the rotational centerline of the selector shaft.

11. The selector shaft of claim 10 wherein said multiple defined locations are equally spaced apart from one another and equally distant from the rotational centerline of the selector shaft.
